(19) United States
(12) Patent Application Publication
(10) Pub. No.: US 2007/0110092 A1
(43) Pub. Date: May 17, 2007

(54) System and method to support priority in wireless LAN mesh networks

(75) Inventors: Shantanu Kangude, Dallas, TX (US); Harshal Shantanu Chhaya, Plano, TX (US); Xiaolin Lu, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/432,167

(22) Filed: May 11, 2006

Related U.S. Application Data
(60) Provisional application No. 60/680,681, filed on May 13, 2005.

(51) Int. Cl. H04L 12/413

(52) U.S. Cl. 370/448

(57) ABSTRACT

A device in a wireless LAN mesh network is disclosed. The device consists of a transceiver operable to send and receive a data packet in the mesh network and a component operable upon detection of a collision with a high priority data packet transmitted by the transceiver to add a small number of backoff times to a contention window associated with the high priority data packet and substantially randomly select a backoff time from the enlarged contention window, the component operable to promote retransmission of the high priority data packet during the selected backoff time after an interface spacing.

### CROSS-REFERENCE TO RELATED APPLICATIONS

This application claims priority to U.S. Provisional Application No. 60/680,681 filed May 13, 2005, entitled “Method to Support HCCA Priority in Wireless LAN Mesh Networks”, Shantanu Kangude, et al. inventors, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to wireless LAN mesh networks, and more particularly, but not by way of limitation, to a system and method for establishing a transmission sequence for data packets transmitted within wireless LAN mesh networks.

### BACKGROUND OF THE INVENTION

Traditional wireless local area networks (LANs) typically have a central server that acts as a controller and coordinator for data traffic among the stations in the network. The server can provide quality of service (QoS) features such as prioritization of data packets to ensure that higher priority data takes precedence over lower priority data. IEEE specification 802.11e defines the protocols for the prioritization of data packets in such wireless networks. Two channel access schemes are defined in 802.11e for QoS in wireless LANs: enhanced distributed channel access (EDCA) and hybrid coordination function (HCF) controlled channel access (HCCA).

In EDCA, traffic is assigned to one of four priority classes or access categories before transmission. The access categories, in order of decreasing priority, are voice, video, best effort, and background. Two parameters that can distinguish the different access categories are interframe spacing (IFS) and contention window size. IFS is the amount of time a station must wait before attempting to transmit a data packet or data frame (the two terms, data packet and data frame, will be used interchangeably herein). A station may use a shorter IFS when transmitting higher priority data packets to increase the likelihood that higher priority packets will be transmitted before lower prior packets.

802.11e specifies three IFSs, known as Short Interframe Space (SIFS), PCS Interframe Space (PIFS), and Arbitration Interframe Spacing (AIFS). AIFS is substantially equivalent to DCF Interframe Space (DIFS) or to DIFS plus a small number of slot times. DIFS is typically used for ordinary traffic and has the longest interframe space among DIFS, SIFS, and PIFS and therefore provides the lowest priority. PIFS is typically used by a central controller in polling the stations in a LAN or for management traffic such as beacon frames. PIFS has a shorter interframe space and therefore higher priority than DIFS. SIFS is typically used for control traffic, as opposed to ordinary data traffic, and has the shortest interframe space and therefore provides the highest priority.

The contention window contains a range of different wait times, known as backoff times, that might be added to the IFS wait time. The backoff times might also be thought of as time slots within the contention window, where each time slot corresponds to a different location in a transmission sequence. The length of each time slot depends on the version of the 802.11 standard being employed, with time slots of 20 microseconds being used in 802.11b and time slots of nine microseconds being used in 802.11a.

If two stations within a wireless mesh network attempt to transmit data at the same time, a collision occurs and neither is able to transmit. Under 802.11e, the two stations would then each randomly choose a backoff time from the backoff times available in the contention window, add the randomly chosen backoff times to the IFS, and attempt to transmit again after total wait times equal to the IFS plus the randomly chosen backoff times. The station with the lower total wait time would have the higher priority since a packet with a shorter wait time will be transmitted before a packet with a longer wait time.

It is likely that the backoff times that the two stations randomly choose from the contention window will be different from one another so that the stations will attempt to retransmit at different times and no collision will occur. If the two stations happen to randomly choose the same backoff time from the contention window, another collision will occur. In that case, 802.11e specifies that the size of the contention window should be doubled, backoff times should be randomly selected from the expanded contention window, and the selected backoff times should be added to the interframe spacings to obtain new total wait times.

As an example, a typical initial contention window might consist of an array of four different backoff times or four different time slots. If a collision occurs, the size of the contention window would be doubled from four backoff times or times slots to eight backoff times or times slots. Each station would then again randomly choose a backoff time from the range of backoff times in the contention window. The larger size of the contention window and the greater number of backoff times in the contention window reduce the probability of the two stations randomly choosing the same backoff time.

If the two stations again happen to choose the same backoff time, the size of the contention window is again doubled and new backoff times are again chosen from the expanded contention window. The doubling of the contention window size continues until the two stations are able to successfully transmit their data frames without collisions or until a maximum contention window size is reached. In this way, two stations are assured of eventually transmitting their packets at different times and thus avoiding collisions.

This EDCA channel access scheme has a probabilistic nature and cannot ensure that high priority data packets will always be transmitted before low priority data packets. The higher priority access categories are given shorter lFSs and smaller initial contention windows to increase the likelihood of higher priority packets choosing small backoff times and therefore being transmitted before low priority packets. However, it is possible that a low priority packet could randomly choose a smaller backoff time than a high priority packet and be transmitted before the high priority packet.

The other 802.11e channel access scheme, HCCA, provides a guaranteed level of service. Under HCCA, an access point in a LAN acts as a controller and coordinator for the data traffic in the LAN. The access point is informed by the stations about the type of traffic and the priority of the data packets they are attempting to transmit. The access point then causes the transmissions to occur in an appropriate sequence based on the priorities by polling the stations. Since the polling uses PIFS, which has a smaller interframe spacing, the access point gets priority over all other stations and ensures that a certain priority order is followed. HCCA, therefore, is a deterministic system that can ensure that collisions do not occur and that high priority packets precede low priority packets. However, HCCA requires the presence of a central controller to oversee data traffic among all the stations in a network.

### SUMMARY OF THE INVENTION

In one embodiment, a method for sequencing transmission of data packets in a wireless LAN mesh network is provided. The method consists of, when a collision occurs between a higher priority data packet and a lower priority data packet, increasing a number of backoff times in a contention window associated with the higher priority data packet by a number less than an initial size of the contention window associated with the higher priority data packet, randomly selecting a backoff time for the higher priority data packet from the contention window associated with the higher priority data packet, and transmitting the higher priority data packet during the backoff time selected from the contention window associated with the higher priority data packet.

In another embodiment, a device in a wireless LAN mesh network is provided. The device consists of a transceiver operable to send and receive a data packet in the mesh network and a component operable upon detection of a collision with a high priority data packet transmitted by the transceiver to add a small number of backoff times to a contention window associated with the high priority data packet and substantially randomly select a backoff time from the enlarged contention window, the component operable to promote retransmission of the high priority data packet during the selected backoff time after an interface spacing.

In another embodiment, an alternative device in a wireless LAN mesh network is provided. The device consists of a transceiver operable to send and receive a data packet in the mesh network and a component operable to arrange a transmission order for a first transmission of a data packet to reduce collisions with other data packets transmitted within the mesh network.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of a portion of a mesh network in which data packets are sequenced by their priority according to an embodiment of the disclosure.

FIG. 2 is a diagram of a method for sequencing data packets in a mesh network according to an embodiment of the disclosure.

FIG. 3 is a diagram of an alternative method for sequencing data packets in a mesh network according to an embodiment of the disclosure.

FIG. 4 illustrates an exemplary general-purpose computer system suitable for implementing the several embodiments of the present disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

A mesh network can be defined as a LAN that has no central coordinator or scheduler for the data traffic in the LAN. A wireless mesh network typically comprises a plurality of mobile stations such as laptop computers and handheld computers. Such stations can be referred to as mesh points. A wireless mesh network might also include a plurality of fixed or mobile access points with which the mesh points can communicate. The access points might be capable of communicating with other networks, such as the Internet. Combination mesh/access points might also be present in a mesh network.

Rather than communicating exclusively with a single access point, as might be the case in a traditional wireless network, each mesh point might choose which of the plurality of access points it communicates with at any given time. Over an extended period of time, a single mesh point might move over an extended geographical area and communicate with several different access points. A mesh point might also communicate directly with one or more other mesh points. A data packet transmitted by a mesh point might pass through multiple other mesh points before reaching an access point.

When a mesh network carries high priority data, such as data in the voice or video access categories, a high level of quality of service (QoS) may be needed to ensure that high priority data packets are likely to be transmitted before low priority data packets. For example, voice and video data packets typically need to be transmitted in a specific order and at constant rate. The transmission of a low priority packet prior to a high priority packet could disrupt this order or rate and cause defects in a voice or video transmission. The 802.11e QoS specifications may not be adequate to ensure that voice and video data packets in a mesh network receive the priority they require.

More specifically, the HCCA channel access scheme can provide a high level of QoS in traditional wireless networks since HCCA is a deterministic approach that can strictly control the transmission order of data packets. However, HCCA is inappropriate for mesh networks since HCCA requires a central data traffic controller and no such central controller is present in a mesh network.

The EDCA channel access scheme, on the other hand, can easily be adapted to mesh networks because EDCA does not require a central controller. However, EDCA is a probabilistic approach that may be inadequate to ensure QoS for high priority data. The lack of determinism in EDCA could allow a low priority packet to precede a high priority packet. This could lead to distortion, delay, jitter, and other poor service quality outcomes for voice or video transmissions.

Embodiments of the present disclosure provide a channel access scheme for mesh networks that approaches the determinism of HCCA but that does not require the presence of a central controller. This scheme, which can be referred to as Coordinated HCCA, or C-HCCA, is a modified form of EDCA and is thus somewhat probabilistic. However, the randomness in specifying packet transmission order that is inherent in traditional EDCA is greatly reduced. High priority data packets, such as voice and video packets, have a high likelihood of receiving the priority they need to prevent poor quality in voice or video transmissions.

As mentioned previously, data traffic under EDCA is prioritized by placing the traffic in one of four access categories: voice, video, best effort, and background. In an embodiment, a new, fifth EDCA access category is created in addition to the four existing categories. Data traffic in this fifth access category is highly likely to be transmitted prior to traffic in the other four access categories. Voice, video, and other high priority traffic in a mesh network can be placed in the fifth access category to increase the likelihood that such traffic will take precedence over lower priority traffic.

Two modifications are made to the parameters of the previous access categories to create the fifth access category: a change in the algorithm for increasing the size of the contention window and a change in the designation of the interframe spacing for data traffic in the fifth category. Under traditional EDCA, the size of the contention window is doubled each time a collision occurs. In the current embodiments, the size of the contention window for fifth category data packets is increased by a small, constant amount, such as three, each time such a data packet undergoes a collision. Alternatively, the size of the contention window could be multiplied by a factor less than two each time a collision occurs. This small contention window size increase applies only to fifth category data packets; the size of the contention window for data packets in the other four access categories is doubled as in the prior art.

As an example, the initial contention window for fifth category data packets might contain four time slots. If a collision occurred between two fifth category data packets, three time slots might be added to the contention windows for the data packets, increasing the contention window size from four time slots to seven. If a collision occurred between a fifth category data packet and a data packet from one of the other four access categories, the size of the collision window of the fifth category data packet would be increased by three time slots and the size of the collision window for the data packet in the other access category would be doubled as in traditional EDCA.

The two mesh points that transmitted the data packets that collided would randomly choose backoff times from the expanded contention windows, wait total times equal to the backoff times plus the appropriate interframe spacing, and attempt to retransmit. If another collision occurred, three time slots would again be added to the contention window size of the fifth category data packet or data packets, increasing the contention window size to ten time slots. If a data packet from another access category were involved in the collision, its collision window size would again be doubled. The mesh points would again randomly choose backoff times from the further expanded contention windows and again attempt to retransmit. This process would continue until the mesh points chose different backoff times and were thus able to transmit without collision.

While the selection of backoff times was described above as being random, it should be understood that the selection process is not necessarily totally random. A selection method that is substantially, but not strictly, random could be used. As used herein, the terms “random” and “randomly” refer to processes that have no deliberately assigned pattern or regularity.

The addition of a small constant amount to the size of the contention window for fifth category data packets rather than doubling the size of the contention window increases the likelihood of a small backoff time being selected for fifth category data packets. The increased likelihood of having a small backoff time results in an increased likelihood that fifth category data packets will be transmitted before data packets in the other four access categories. This, in turn, gives voice, video, and other fifth access category data packets a higher priority than packets in the other access categories.

The interframe spacings used for data traffic in the fifth access category also contribute to a higher priority for data packets in the fifth category. While data traffic in the four previous access categories typically uses the long interframe spacing of DIFS, the interframe spacing for the fifth access category is specified to be either SIFS or PIFS. In an embodiment, SIFS is used when the previous transmission ended successfully or when the previous transmission opportunity ended without a transmission. PIFS is used when the previous transmission did not end successfully. The use of the shorter interframe spacings of SIFS and PIFS gives data packets in the fifth access category a higher priority than packets in the other four access categories.

While the above modifications can increase the likelihood of C-HCCA data packets being transmitted before packets in the previous four EDCA access categories, C-HCCA is still a probabilistic system that may not guarantee that high priority packets will be transmitted before low priority packets. In an embodiment, C-HCCA is modified to further ensure that packets in the fifth access category receive a high priority. In this version of C-HCCA, which can be referred to as C-HCCA-B, a bias is added to the random selection process for the initial backoff times such that multiple mesh points are unlikely to select the same initial backoff times. With different initial backoff times, the mesh points are unlikely to collide when transmitting data packets. The low probability of collisions among packets following C-HCCA-B makes C-HCCA-B more deterministic than C-HCCA and further increases the priority of data packets in the fifth access category.

Several methods can be used to add biasing to the selection of the original backoff times. In one embodiment, the Add Traffic Specification (ADDTS) request packets sent out by mesh points attempting to join a mesh network are used to provide biasing. For traditional wireless networks, an ADDTS request is a data packet sent from a network station to an access point requesting that the access point grant the station access to the network. In a mesh network, a mesh point might broadcast an ADDTS request to all access points and all other mesh points in the mesh network rather than directing the ADDTS request only to a single access point. The ADDTS request might specify a time instant and periodicity with which the mesh point intends to transmit a data packet.

In an embodiment, the mesh points in a mesh network retain information contained in the ADDTS requests that are broadcast by the other mesh points and use this information to select a time slot in which to attempt to transmit. For example, a mesh point attempting a first transmission of a data packet might determine the expected transmission times of the other data packets waiting to be transmitted. The mesh point might then place the data packet in a location in a data transmission sequence in which the data packet is scheduled to be transmitted at a time different from the expected transmission times of the other data packets. Since the actual transmission time for a data packet is not necessarily the same as its expected transmission time, a collision could still occur with this method, but the likelihood of a collision is greatly reduced.

In an embodiment, if C-HCCA-B is used and a collision does occur between two fifth category packets or between a fifth category packet and a packet from one of the other four access categories, the steps described above for C-HCCA are then followed. That is, a small amount, such as three, is added to the size of the fifth category contention window, a new backoff time is selected from the expanded contention window, an interframe spacing of SIFS or PIFS is used, and retransmission is attempted. This process continues until transmission is successful.

In other embodiments, biasing could be added to C-HCCA in other manners. For example, basic state information could be maintained for the mesh points in a mesh network and/or for the data packets transmitted by the mesh points and this state information could be used to increase the likelihood that mesh points select non-conflicting backoff times. In one instance of the use of state information, a medium access control (MAC) address or other identifying characteristic for a mesh point could be used to specify a location in a transmission sequence for the mesh point.

Regardless of how biasing is added to C-HCCA to create C-HCCA-B, the biasing reduces the randomness of the backoff time selection process and increases the determinism in the assignment of transmission times to data packets. With C-HCCA-B, the prioritization of data packets in mesh networks can approach the level of determinism available in standard HCCA in traditional wireless networks but without the need for a central controller as required in standard HCCA. This can increase the likelihood of voice, video, and other high priority data being transmitted in a mesh network without significant loss of quality.

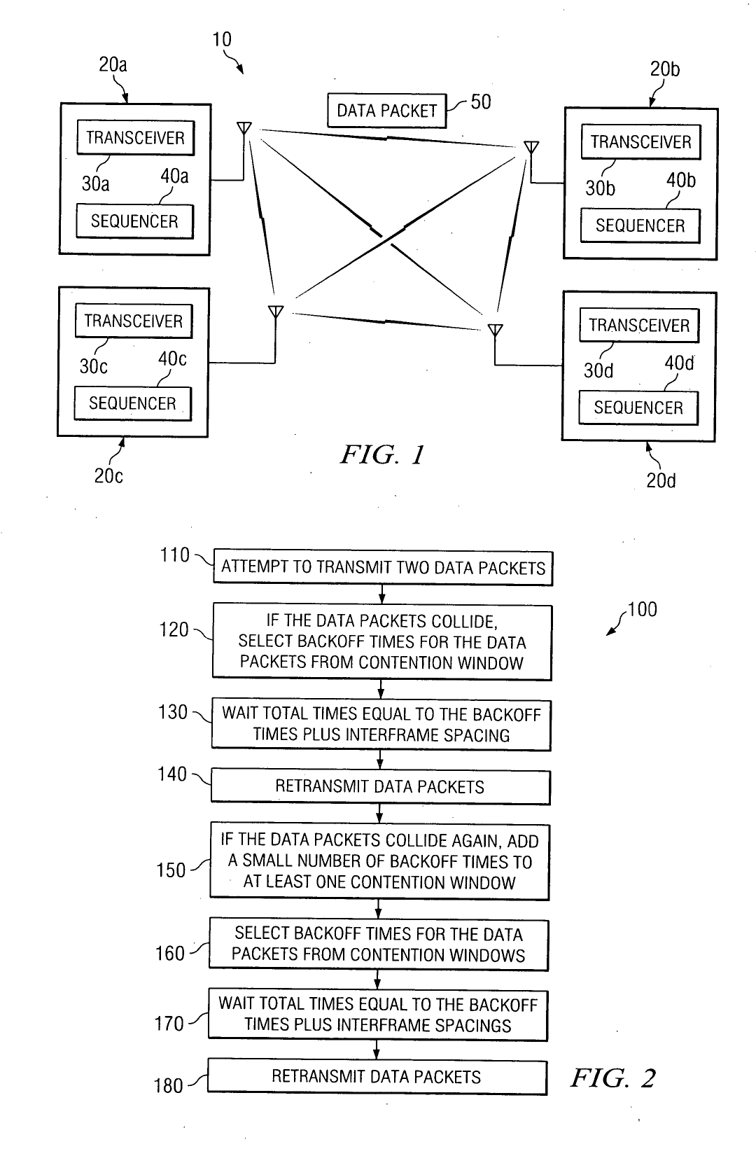

FIG. 1 illustrates a mesh network 10 that includes a plurality of devices 20. Only a first device 20a, second device 20b, third device 20c, and fourth device 20d are shown but other devices might be present. The devices 20 might be mesh points, access points, combination mesh/access points, computers, laptop computers, portable computers, servers, other systems associated with mesh or access points, or other components commonly deployed in mesh networks. Each device 20 includes a transceiver 30 capable of wirelessly sending and receiving a data packet 50.

Each device 20 also includes a component 40 operable to establish a transmission sequence for the data packets that each device 20 transmits. The component 40 might include rules or protocols for packet counting. More specifically, the component 40 might ensure that each time a fifth category data packet is involved in a collision, the size of the contention window from which a backoff time for the data packet is chosen is increased by three or some other small number. Alternatively, the size of the contention window could be multiplied by a factor less than two each time a collision occurs. The component 40 might also ensure that the interframe spacing used in the transmission of fifth category data packets is either SIFS or PIFS.

The component 40 might also, prior to first attempting to transmit a fifth category data packet, place the data packet in a location in a transmission sequence in which the data packet is unlikely to undergo a collision. The placement of the data packet in the transmission sequence might be based on an expected transmission time contained in an ADDTS request or on some other means for ordering a sequence of data transmissions. If a data packet placed in a transmission sequence in this manner does undergo a collision, further attempts at transmission of the data packet can be based on the small increases in the contention window size and the short interframe spacings as described above.

FIG. 2 illustrates a method 100 for establishing a sequence for transmitting data packets in a wireless LAN mesh network. In box 110, two mesh points or devices each attempt to transmit data packets in the mesh network. In box 120, if two data packets collide, a backoff time for each data packet is substantially randomly selected from a contention window. In box 130, each device waits a total time equal to the backoff time selected for it plus an interframe spacing. The data packets are then retransmitted in box 140.

In box 150, if the two data packets again collide, a small number of backoff times are added to at least one of the contention windows. For example, if one of the contention windows has a size of seven, three might be added to the contention window size to give a contention window size of ten. In other embodiments, the amount added to the contention window could be more or less than three. If the two data packets are both fifth category packets, a small number of backoff times are added to the contention windows used by both devices transmitting the packets. If one of the data packets is a fifth category packet and the other packet is in another access category, a small number of backoff times are added to the contention window used by the fifth category packet and the size of the contention window used by the other data packet is doubled.

In box 160, a backoff time for each data packet is randomly selected from each packet's contention window. In box 170, each device again waits a total time equal to the backoff time selected for it plus an interframe spacing. For a fifth category data packet, the interframe spacing is specified to be either SIFS or PIFS. The data packets are then retransmitted in box 180. The process of selecting new backoff times from contention windows that have been expanded in this manner can continue until the data packets are transmitted without collision.

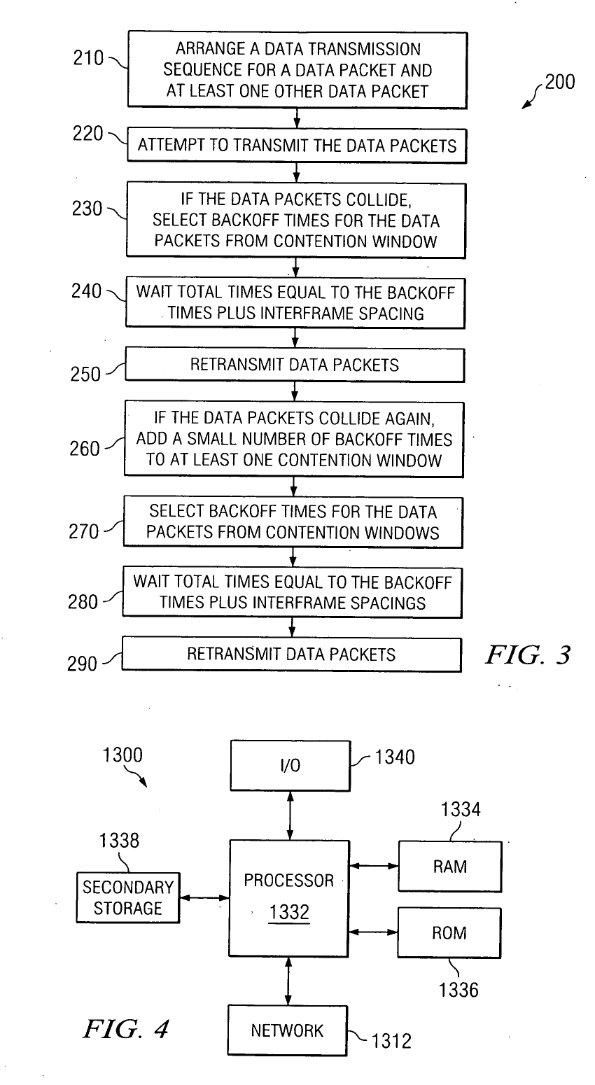

FIG. 3 illustrates a method 200 for reducing the likelihood that a data packet in a wireless LAN mesh network will undergo a collision. In box 210, a data transmission sequence is arranged for a device and a data packet and at least one other device and data packet in the mesh network. The arrangement might be based on the expected transmission times of the data packets as specified in the ADDTS requests made by the devices, on the MAC addresses of the devices, or on some other state information related to the devices or data packets.

In box 220, two mesh points or devices each attempt to transmit a data packet. In box 230, if two data packets collide, a backoff time for each data packet is randomly selected from a contention window. In box 240, each device waits a total time equal to the backoff time selected for it plus an interframe spacing. The data packets are then retransmitted in box 250.

In box 260, if the two data packets again collide, a small number of backoff times are added to at least one of the contention windows. For example, if one of the contention windows has a size of seven, three might be added to the contention window size to give a contention window size of ten. In other embodiments, the amount added to the contention window could be more or less than three. If the two data packets are both fifth category packets, a small number of backoff times are added to the contention windows used by both devices transmitting the packets. If one of the data packets is a fifth category packet and the other packet is in another access category, a small number of backoff times are added to the contention window used by the fifth category packet and the size of the contention window used by the other data packet is doubled.

In box 270, a backoff time for each data packet is randomly selected from each packet's contention window. In box 280, each device again waits a total time equal to the backoff time selected for it plus an interframe spacing. For a fifth category data packet, the interframe spacing is specified to be either SIFS or PIFS. The data packets are then retransmitted in box 290. Again, the process of selecting new backoff times from contention windows that have been expanded in this manner can continue until the data packets are transmitted without collision.

The mesh points, access points, and other wireless LAN mesh network components described above may be implemented on any general-purpose computer with wireless communications capabilities and with sufficient processing power, memory resources, and network throughput capability to handle the necessary workload placed upon it. FIG. 4 illustrates a typical, general-purpose computer system suitable for implementing one or more embodiments disclosed herein. The computer system 1300 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an over-flow data storage device if RAM 1334 is not large enough to hold all working data. Secondary storage 1338 may be used to store programs that are loaded into RAM 1334 when such programs are selected for execution. The ROM 1336 is used to store instructions and perhaps data that are read during program execution. ROM 1336 is a non-volatile memory device that typically has a small memory capacity relative to the larger memory capacity of secondary storage. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from a network or might output information to a network in the course of performing the above-described method steps.

Such information, which may include data or instructions to be executed using processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, or scripts that it accesses from hard disk, floppy disk, optical disk (these various disk-based systems may all be considered secondary storage 1338), ROM 1336, RAM 1334, or the network connectivity devices 1312.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method for sequencing transmission of data packets in a wireless LAN mesh network, comprising:
when a collision occurs between a higher priority data packet and a lower priority data packet, increasing a number of backoff times in a contention window associated with the higher priority data packet by a number less than an initial size of the contention window associated with the higher priority data packet;
randomly selecting a backoff time for the higher priority data packet from the contention window associated with the higher priority data packet; and
transmitting the higher priority data packet during the backoff time selected from the contention window associated with the higher priority data packet.

2. The method of claim 1, further comprising:
after the collision between the higher priority data packet and the lower priority data packet, doubling a number of backoff times in a contention window associated with the lower priority data packet;
randomly selecting a backoff time for the lower priority data packet from the contention window associated with the lower priority data packet; and
transmitting the lower priority data packet during the backoff time selected from the contention window associated with the lower priority data packet.

3. The method of claim 1, wherein the transmission is according to an HCCA ((HCF Hybrid Coordination Function) Controlled Channel Access) protocol.

4. The method of claim 1, wherein the higher priority data packet is defined as a 5^{th} access category data packet, wherein the 5^{th} access category is for higher priority data than 1^{st}-4^{th} access categories.

5. The method of claim 1, wherein the increase in the number of backoff times in the contention window associated with the higher priority data packet is less than a doubling.

6. The method of claim 1, wherein the number of backoff times added to the contention window associated with the higher priority data packet is three.

7. The method of claim 1, wherein the higher priority packet transmission is after an interframe spacing of one of:
SIFS; and
PIFS.

8. The method of claim 1, further comprising, prior to a first attempt at transmitting the higher priority data packet, placing the higher priority data packet in a location in a sequence to reduce collisions between the higher priority data packet and other data packets, the sequence related to the transmission of other data packets by other devices in the mesh network.

9. The method of claim 8, wherein the placement of the higher priority packet is based on an expected transmission time of the one more of the other devices in the mesh network.

10. A device in a wireless LAN mesh network, comprising:
a transceiver operable to send and receive a data packet in the mesh network; and
a component operable upon detection of a collision with a high priority data packet transmitted by the transceiver to add a number of backoff times to a contention window associated with the high priority data packet and substantially randomly select a backoff time from the enlarged contention window, the component operable to promote retransmission of the high priority data packet during the selected backoff time after an interface spacing, and wherein the number of backoff times added to the contention window is less than an initial size of the contention window associated with the higher priority data packet.

11. The device of claim 10, wherein the number of backoff times added to the contention window associated with the high priority data packet is less than 5.

12. The device of claim 10, wherein the interframe spacing is one of:
SIFS; and
PIFS.

13. The device of claim 10, wherein the component is further operable for lower priority packets to double the number of backoff times in a contention window associated with the lower priority data packets and to substantially randomly select another backoff time from the doubled contention window.

14. The device of claim 10, wherein, prior to a first attempt at transmitting the high priority data packet, the component places the data packet in a location in a sequence for transmission to reduce collisions with other data packets.

15. The device of claim 14, wherein the location of the data packet in the sequence for transmission is based on an expected transmission time of the data packet and expected transmission times of the other data packets.

16. A device in a wireless LAN mesh network, comprising:
a transceiver operable to send and receive a data packet in the mesh network;
a component operable to arrange a transmission order for a first transmission of a data packet to reduce collisions with other data packets transmitted within the mesh network.

17. The device of claim 16, wherein the transmission order is based on an expected transmission time of the device and other devices in at least a portion of the mesh network.

18. The device of claim 16, wherein the transmission order is based on state information related to the device and at least some of the other devices in the mesh network.

19. The device of claim 18, wherein the state information is a MAC address of the devices.

20. The device of claim 16, wherein the transmission order is based is on an Add Traffic Specification (ADDTS) expected transmission order of the device and other devices in at least a portion of the mesh network.
